(19) United States
(12) Patent Application Publication
(10) Pub. No.: US 2006/0090671 A1
(43) Pub. Date: May 4, 2006

(54) Tamper-evident lid for container

(76) Inventor: Len Ekkert, Lemont, IL (US)

Correspondence Address: WELSH & KATZ, LTD, 120 S RIVERSIDE PLAZA, 22ND FLOOR, CHICAGO, IL, 60606, US

(21) Appl. No.: 10/977,919

(22) Filed: Oct. 29, 2004

(51) Int. Cl. C09C 1/00

(52) U.S. Cl. 106/439

(57) ABSTRACT

A container is provided with an openable lid. The container includes a post disposed on the food container, a loop section adapted to engage the post and a breakable link adapted to secure the loop section to the openable lid.

### FIELD OF THE INVENTION

The field of the invention relates to containers used for human ingestible products and more particularly to tamper-evident lids for containers holding human ingestible products.

### BACKGROUND OF THE INVENTION

Product tampering is a well-known problem. A well-known example of product tampering has included the substitution of poison for aspirin in aspirin capsules.

While the most well-know examples of product tampering has involved drug containers, the potential for product tampering exists for virtually any human ingestible product. Further, the tendency of most stores to allow self-service of product provides a ready opportunity for criminals to alter a product and then return the altered product to a store's shelves.

While product tampering cannot be absolutely prevented, most efforts in the past have been directed towards providing product seals that readily show evidence of tampering. For example, many bottled products are now sold with heat-shrinkable tubing disposed around a neck and cap of the bottle. Any attempt to open the bottle usually results in damage to the tubing thereby providing visual warning to a potential buyer that the bottle may have been tampered with.

In the case of products sold in boxes, the process becomes more difficult. In the case of boxes, adhesive tape may be used to seal a reclosable lid. However, many boxes of this type are plastic and it is often possible to remove the adhesive tape without damage, thereby again providing the opportunity for tampering. Accordingly, a need exists for a method of sealing boxes that is reliable, yet easy for a consumer to overcome during the normal course of use of the product within the box.

### SUMMARY

A container is provided with an openable lid. The container includes a post disposed on the container, a loop section adapted to fixedly engage the post and a breakable link adapted to secure the loop to the openable lid.

### BRIEF DESCRIPTION OF THE DRAWINGS

FIG. 1 is a top perspective view of a tamper-evident box in accordance with an illustrated embodiment of the invention;

FIG. 2 is a partial top perspective view of the lids of the box of FIG. 1 after the lids have been opened;

FIG. 3 is a cut-away view of the lids of FIG. 1;

FIG. 4 is a top perspective view of a tamper-evident container with a screw-on top in accordance with an illustrated embodiment of the invention;

FIG. 5 is a top perspective view of the tamper-evident container of FIG. 4;

FIG. 6 is a top perspective view of a tamper-evident container of FIG. 4 with a screw-on top and an ellipsoidal post and loop section;

FIG. 7 is a top perspective view of the tamper-evident container of FIG. 6; and

FIG. 8 depicts top and bottom views of the box of FIG. 1 showing a complementary recess on the bottom of the box.

### DETAILED DESCRIPTION OF AN ILLUSTRATED EMBODIMENT

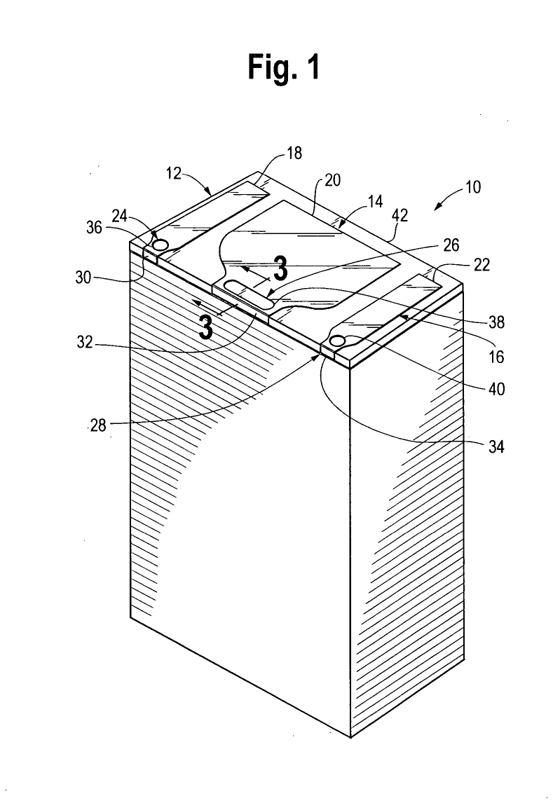

FIG. 1 is a top perspective view of a container (e.g., a box) 10 shown generally in accordance with an illustrated embodiment of the invention. The container 10 may be for a human ingestible product (e.g., a spice box) or for any other product where there is an economic or legal incentive to alert a buyer to tampering. Provided on the container 10 may be one or more tamper-evident lids 12, 14, 16 that allow access to the product within the container 10, but which provides visual evidence of tampering to the consumer before purchase.

Each tamper evident lid 12, 14, 16 may be provided with a hinge 18, 20, 22 on a first end of the lid 12, 14, 16 and a tamper evident locking mechanism (system) 24, 26, 28 on a second, opposing end. The tamper evident locking mechanism 24, 26, 28 may be provided on a tab 30, 32, 34 that extends from a distal end of each lid 12, 14, 16 opposite the hinge 18, 20, 22.

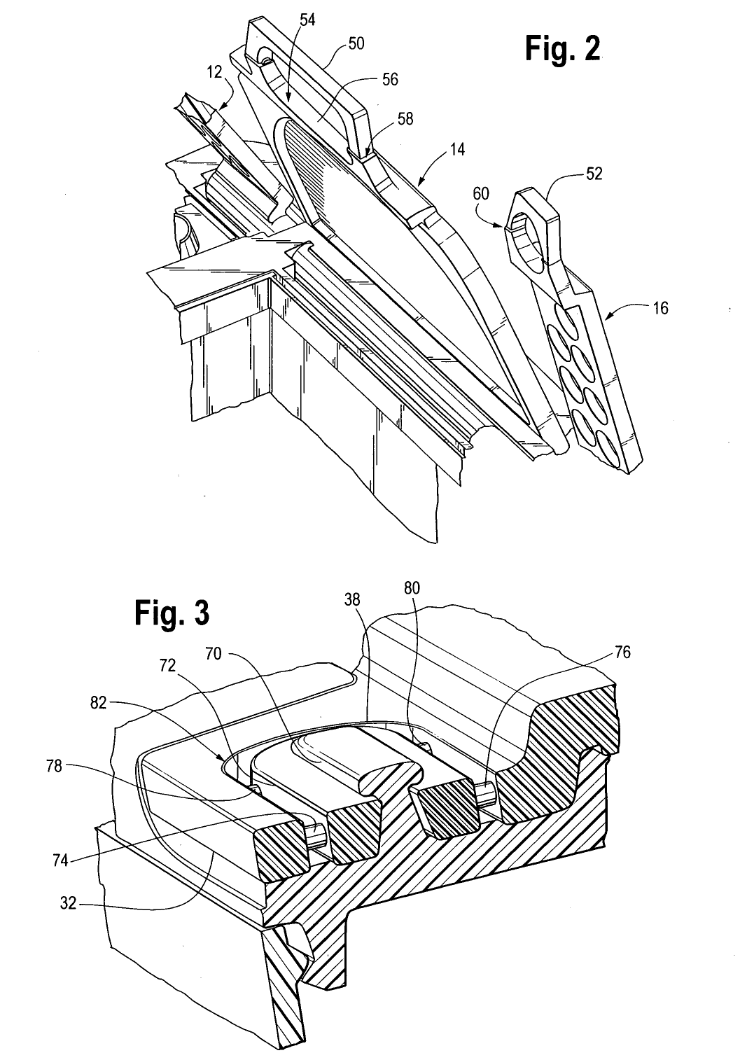

The tamper evident locking mechanism 24, 26, 28 may be provided as a two part assembly that includes a deformable tip and breakable links. FIG. 2 is a perspective view of the container 10 of FIG. 1 with the lids 12, 14, 16 in an opened state. As may be noted from FIG. 2, upon opening, the tips 50, 52 of the tabs 30, 32, 34 assume a deflected state caused by a transverse fracturing of a tip of the tab 30, 32, 34. The transverse fracturing may occur along score lines 58, 60 or along some other weakened area or structure of the tabs 30, 32, 34.

To open the lids 12, 14, 16, a consumer or tampering party (not shown) may use a tool (e.g., a knife) to pry open the container or closure. To open the container 10, the consumer may insert the knife under the lid 12, 14, 16 and pry up the tab 30, 32, 34. Prying on the tab 30, 32, 34 causes the tab 30, 32, 33 to fracture along the score lines 58, 60 allowing the tip 50, 52 to deflect upwards as a first sign of an initial opening of the container 10 (e.g., product tampering). A second sign of tampering results from the fracturing of a set of breakable links.

The term “initial opening” of the lid refers to the step of forcing the lid open resulting in visible damage to the container. The visible damage may result from a transverse fracturing of the tab on the lid along the scoring and in fracturing of the breakable links that connect the annular loop to the post. The initial opening of the lid provides tamper evidence in the form of the visually apparent fractured tab and/or broken links.

FIG. 3 shows a cut-away view of the locking mechanism 26 of lid 14. Locking mechanisms 24, 28 are substantially similar.

As shown in FIG. 3, the locking mechanism 24, 26, 28 of each lid 12, 14, 16 may contain a center post aperture 82 disposed within a center portion of each tab 30, 32, 34 of each lid 12, 14, 16.

A center band or annular loop (section) 72 may be disposed within the aperture 82 of each tab 30, 32, 34. The annular loop 72 may be secured to the tab 30, 32, 34 through the use of a set of breakable links 74, 76, 78, 80. The breakable links 74, 76, 78, 80 extend outwards in a radial direction from the annular loop 72 and function to connect the annular loop 72 to a periphery of an aperture 36, 38, 40.

Before the container 10 is opened, the lids 12, 14, 16 may be held in a closed position by a post 70. After filling the container 10 with a product, the manufacturer may close the lid 12, 14, 16 over the post 70, resulting in the loop 72 becoming permanently engaged to the post 70. Under one illustrated embodiment, the manufacturer may apply heat to a tip of the post 70 causing the tip of the post 70 to flatten as shown in FIG. 3. Once heat is applied and the top of the post 70 is flattened, the annular loop 72 cannot be removed from the post without either breaking the post 72 or the links 74, 76, 78, 80.

Under another illustrated embodiment, the post 70 may have a barbed point that allows the loop 72 to be forced over. Once the loop 72 passes over the barb, the loop 72 and post 70 cannot be disengaged without damage to the loop 72 or post 70.

As the consumer or tampering party pries on the tab 30, 32, 34, the deformable tip 50, 52 first bends upwards as shown in FIG. 2. As the consumer continues to pry on the tab 30, 32, 34, the breakable links 74, 76, 78, 80 eventually break to allow the lid 12, 14, 16 to open.

As the breakable links 74, 76, 78, 80 break, the annular loop 72 remains attached to the post 70. The broken links 74, 76, 78, 80 provide additional evidence of tampering that is easily noticed by a consumer considering purchase of the product contained within the container 10.

The locking mechanism 24, 26, 28 may be easily formed into the lids 12, 14, 16 by plastic injection molding. The notches 58, 60 may be formed on opposing sides of the aperture 82 during the same molding process.

A container 10 provided with one or more tamper evident locking systems 24, 26, 28 provides a reliable container for human ingestible product that is easily opened by the consumer. The tamper evident features of the locking systems 24, 26, 28 function to alert the consumer to even the slightest possibility of tampering.

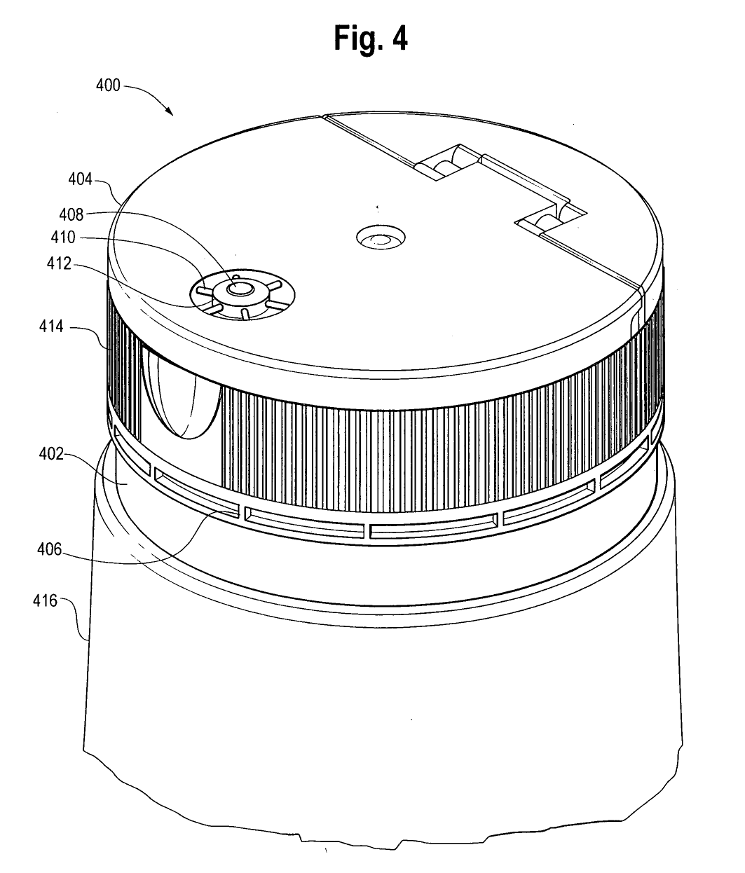

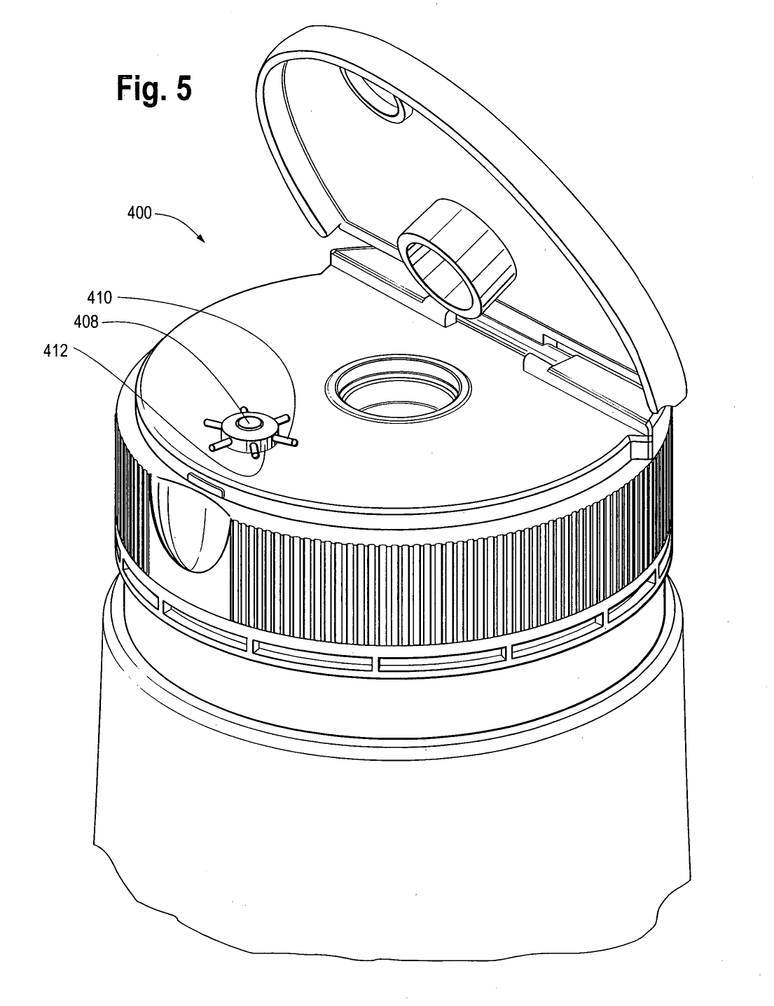

Under another illustrated embodiment, the tamper evident locking system 24, 26, 28 is extended to screw-on caps, as shown in FIGS. 4-7. FIGS. 4 and 5 shows a cap assembly 400 having two levels of security. At a first level, a collar 402 is provided that remains permanently fastened to the container 416. If the cap 414 is unscrewed, a set of breakable links 406 provide evidence of the cap 404 being unscrewed.

On a second level, a post 408 secures an openable lid 404 in a closed position by engaging an annular loop 412 that is connected to the cap 414 through a set of breakable links 410. When the cap 404 is forced open, the links 410 break providing indication of tampering as shown in FIG. 5.

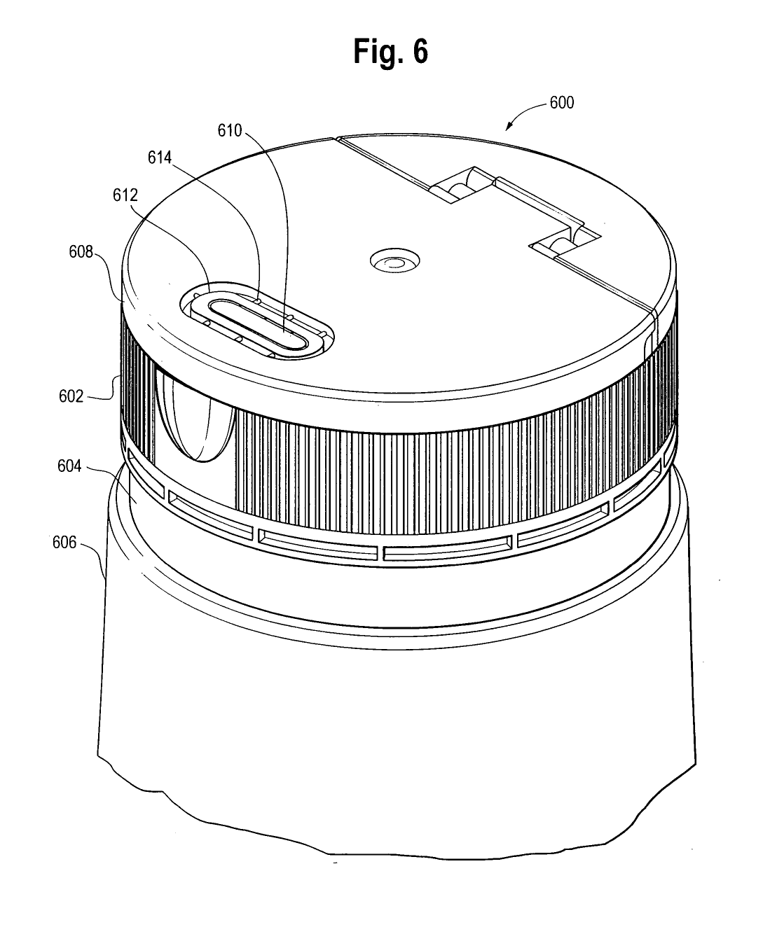

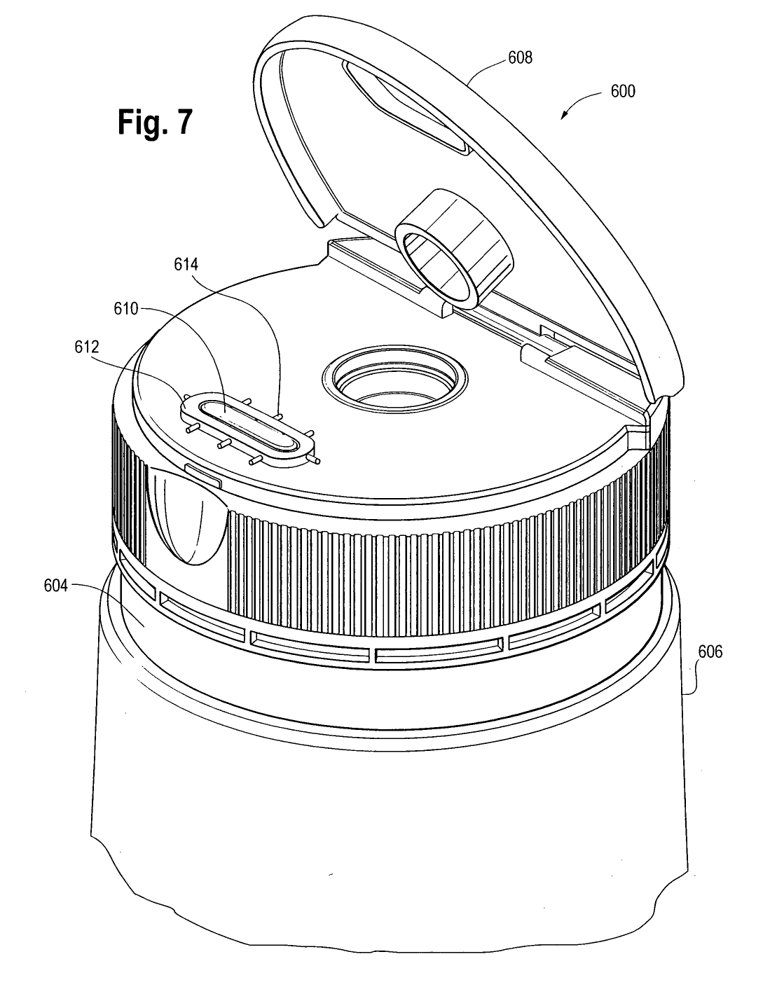

FIGS. 6 and 7 illustrate another embodiment of the invention. In FIGS. 6 and 7, the post 610 has an elongated shape. The loop 612 now has an ellipsoidal shape that matches the elongated shape of the post 610. It should be noted in this regard, that the post and loop may assume any complementary shape and still serve their intended purpose of permanently securing the loop to the post. As with other embodiments, once the lid 608 is pried open, the links 614 break to provide indication of tampering.

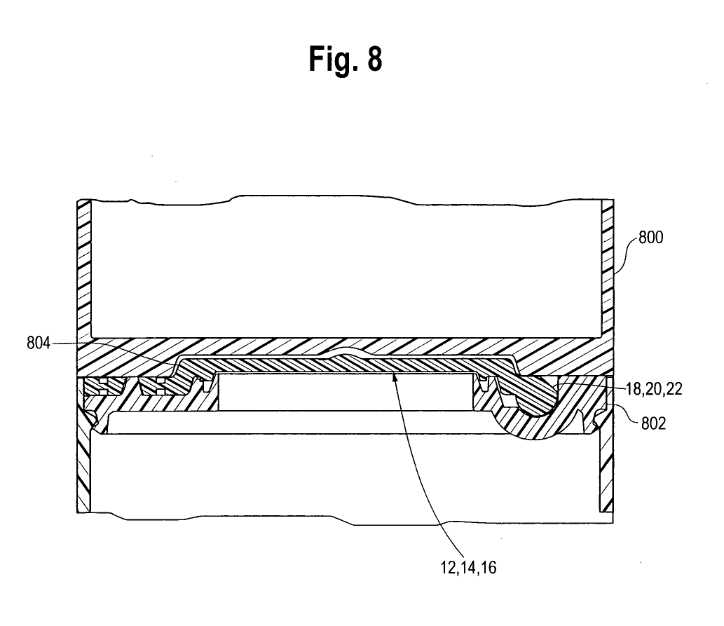

In another illustrated embodiment, the lids 12, 14, 16 may be given a raised profile to allow the hinge 18, 20, 22 to be recessed into an upper surface 42 of the container 10, as shown in FIG. 2 and to allow stacking of the container 10. FIG. 8 shows a first container (now labeled 800) stacked on top of a second container (now labeled 802). As shown in FIG. 8 each of the containers 10 may be provided with a recess 804 on a lower surface of the container 10 that is complementary to the raised profile of the lids 12, 14, 16.

The complementary recess 804 allows containers 10 to be easily stacked on a grocer's shelves. The positive nature of the engagement of the lids 12, 14, 16 into the recess 804 allows stock personnel in grocery stores and otherwise to more easily create a visually pleasing, vertical display with fear of collapse. The engagement of the lids 12, 14, 16 also functions to reduce space in shipping containers used to ship the containers 10 to grocery stores.

Specific embodiments of methods and apparatus for providing tamper-evident packaging according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A container with an openable lid comprising:
a post disposed on the container;
a loop section adapted to permanently engage the post; and
a breakable link adapted to secure the annular loop to the openable lid.

2. The container as in claim 1 further comprising a food dispensing aperture covered by the openable lid with a flexible hinge disposed on a first side of the aperture and a tab extending outwardly from the openable lid on an opposing side of the aperture parallel to a surface of the container surrounding the aperture.

3. The container as in claim 2 further comprising a outer aperture disposed in the tab and arranged to surround the post and loop and wherein the breakable link is secured on a first end to the loop and on a second end to a periphery of the outer aperture.

4. The container as in claim 3 further comprising a plurality of breakable links distributed around the loop, each secured on a first end to the loop and on a second end to a periphery of the outer aperture.

5. The container as in claim 3 wherein the tab further comprises scoring disposed on an under surface of the tab along a transverse line passing through the outer aperture to allow the tab to partially fracture when the openable lid is initially opened.

6. The container as in claim 1 wherein the annular loop further comprises a circular shape.

7. The container as in claim 1 wherein the annular loop further comprises an ellipse or oblong shape.

8. The container as in claim 1 wherein the post further comprises a cross-sectional shape that is complementary to a shape of a center aperture in the annular loop.

9. The container as in claim 1 wherein the post further comprises a length sufficient to extend through a center aperture in the annular loop and to protrude on a distal end from a opposing side of the center aperture.

10. The container as in claim 9 wherein the post further comprises an enlarged tip on the distal end to prevent the annular loop from being disengaged from the post.

11. The container as in claim 9 wherein the post further comprises an integral portion of a body of the container.

12. The container as in claim 9 wherein the post further comprises an integral part of a screw-on cap of the container.

13. The container as in claim 2 wherein the openable lid further comprises a raised profile that extends above the food dispensing aperture.

14. The container as in claim 13 wherein the raised profile of the openable lid further comprises a recess on an opposing side of the container that is complementary to the raised profile of the openable lid.

15. A container with an openable lid comprising:
a body;
a dispensing aperture disposed within a surface of the body, the openable lid being adapted to close the dispensing aperture;
a tab extending outwardly from the lid parallel to the surface of the body surrounding the aperture;
a post aperture disposed in the tab over the surface of the body adjacent the dispensing aperture;
a loop section disposed within the post aperture parallel to the surface of the body;
a breakable link adapted to secure the loop to a periphery of the post aperture; and
a post disposed on the body and adapted to engage a center aperture of the annular loop thereby locking the lid to the body.

16. The container as in claim 15 wherein the tab further comprises scoring along a side adjacent the body extending laterally across the post aperture to allow partial fracturing of the tab during an initial opening of the openable lid.

17. The container as in claim 15 wherein the breakable link is secured on a first end to the loop and on a second end to a periphery of the post aperture.

18. The container as in claim 15 further comprising a plurality of breakable links distributed around the loop section, each secured on a first end to the loop section and on a second end to a periphery of the post aperture.

19. The container as in claim 15 wherein the loop section further comprises an annular loop with a circular shape.

20. The container as in claim 15 wherein the loop section further comprises an oblong shape.

21. The container as in claim 15 wherein the post further comprises a cross-sectional shape that is complementary to a shape of a center aperture in the loop section.

22. The container as in claim 15 wherein the post further comprises a length sufficient to extend through a center aperture in the loop section and to protrude on a distal end from a opposing side of the center aperture.

23. The container as in claim 22 wherein the post further comprises an enlarged tip on the distal end to prevent the loop section from being disengaged from the post.

24. A food container with an openable lid comprising:
a body with a dispensing aperture disposed within a first surface of the body;
the openable lid adapted to close the dispensing aperture, said openable lid further a length and width to cover the dispensing aperture and a thickness to resist breakage; and
a recess within an opposing surface of the body opposite the first side, said recess being adapted to receive the openable lid.

25. The food container as in claim 24 wherein the recess has a length and width complementary to the openable lid.

26. The food container as in claim 24 wherein the recess has a depth complementary to the thickness of the openable lid.
